(19) United States
(12) Patent Application Publication
(10) Pub. No.: US 2005/0244709 A1
(43) Pub. Date: Nov. 3, 2005

(54) Electrode pack

(76) Inventor: Jurgen Bucher, Rottweil (DE)

Correspondence Address: Pauley Petersen & Erickson, Suite 365, 2800 West Higgins Road, Hoffman Estates, IL, 60195, US

(21) Appl. No.: 10/521,219

(22) PCT Filed: Dec. 3, 2003
(86) PCT No.: PCT/EP03/13610

§ 371 Date: Jan. 12, 2005

(30) Foreign Application Priority Data
Dec. 20, 2002 (DE) 102 61 601.9

(51) Int. Cl. H01M 2/08; H01M 2/02; H01M 6/12

(52) U.S. Cl. 429/185; 429/181; 429/162

(57) ABSTRACT

An electrode pack having at least two flat electrodes. The electrodes are placed on a patient and have flat contact areas, which are located on an electrode body and which have a gel, a connecting cable, and have an air-tight closure. A structure that is advantageous for handling and reliability is formed because the closure, while encircling the contact areas, has sealing means joined in an air-tight manner to both electrode bodies, and the connecting cables are guided out of the electrode bodies outside of the sealing means.

### BACKGROUND OF THE INVENTION

1. Field of the Invention

This invention relates to an electrode pack with at least two flat electrodes to be placed against a patient, which have flat contact areas with a gel on an electrode body, as well as connecting cables, and have an airtight connection.

2. Discussion of Related Art

Electrodes are normally used in connection with defibrilators and need to be always capable of functioning, particularly if they are to be always rapidly ready for action in connection with automatic external defibrilators (AEDs). The electrode pack is intended to assure that contact areas are maintained in a functioning status as long as possible. Such an electrode pack is disclosed by U.S. Pat. No. 5,402,884, and similar ones also are disclosed by U.S. Pat. Nos. 5,579,919 and 6,048,640. Here, the packaging seals the two electrodes in an airtight manner, and the cable is also conducted through the packaging in an airtight manner.

### SUMMARY OF THE INVENTION

One object of this invention is to provide an electrode pack of the type mentioned above but which makes possible a simple manipulation and wherein packaging material is saved.

This object is attained with a closure having a seal which surrounds contact areas and are brought into contact in an airtight manner with the electrode bodies, wherein the connecting cables are conducted out of the electrode bodies outside of the sealing apparatus.

Thus the electrodes can be easily separated and removed from the packaging, wherein the connecting cables are not in the way and need not be removed separately from the packaging material. With this construction it is also easy to save packaging material.

One embodiment is advantageous to handle and the construction has sealing means that have an encircling seal ring arrangement, connected in an air-tight manner by connecting means with both electrodes and can be pulled off.

One arrangement is advantageous for the arrangement and handling because the seal ring arrangement has at least one sealing bead formed on each of the facing sides of the electrode bodies which contain the contact areas, which are congruent with respect to the two electrode bodies and are connected with each other by the connecting means. At least one seal ring, which encircles the contact areas, is arranged between the facing sides of the two electrode bodies and is connected with the electrode bodies on each of its two sides facing the electrode bodies by connecting means. Thus the electrodes are also maintained in a defined position facing each other.

If at least one intermediate layer is arranged between the two contact areas facing each other, the contact areas are additionally protected.

In another embodiment for handling the construction has seal ring arrangement that is a part of a foil covering the contact area, which forms at least one insulating intermediate layer between the contact areas facing each other, wherein each part is connected with an associated electrode body by a respective connecting means. The packaging material can be easily removed when the electrodes are separated.

Handling is further simplified because at least one of the two electrodes has a gripping tongue for pulling the two electrodes apart.

In one embodiment the at least one gripping tongue is connected to the seal ring arrangement, or to the at least one intermediate layer.

The functionally ready state of the electrodes is assured because the intermediate layer is integrated as the active means for an electrical electrode test.

### BRIEF DESCRIPTION OF THE DRAWINGS

This invention is explained in greater detail in view of exemplary embodiments, making reference to the drawings, wherein:

FIG. 1A shows a schematic representation of an electrode pack in cross section;

FIG. 1B shows a portion of an electrode pack as shown in FIG. 1A with a modified sealing arrangement;

FIG. 2 shows a top view of the electrode pack shown in FIG. 1A; and

FIG. 3 shows one embodiment of an electrode pack in a side view.

### DESCRIPTION OF PREFERRED EMBODIMENTS

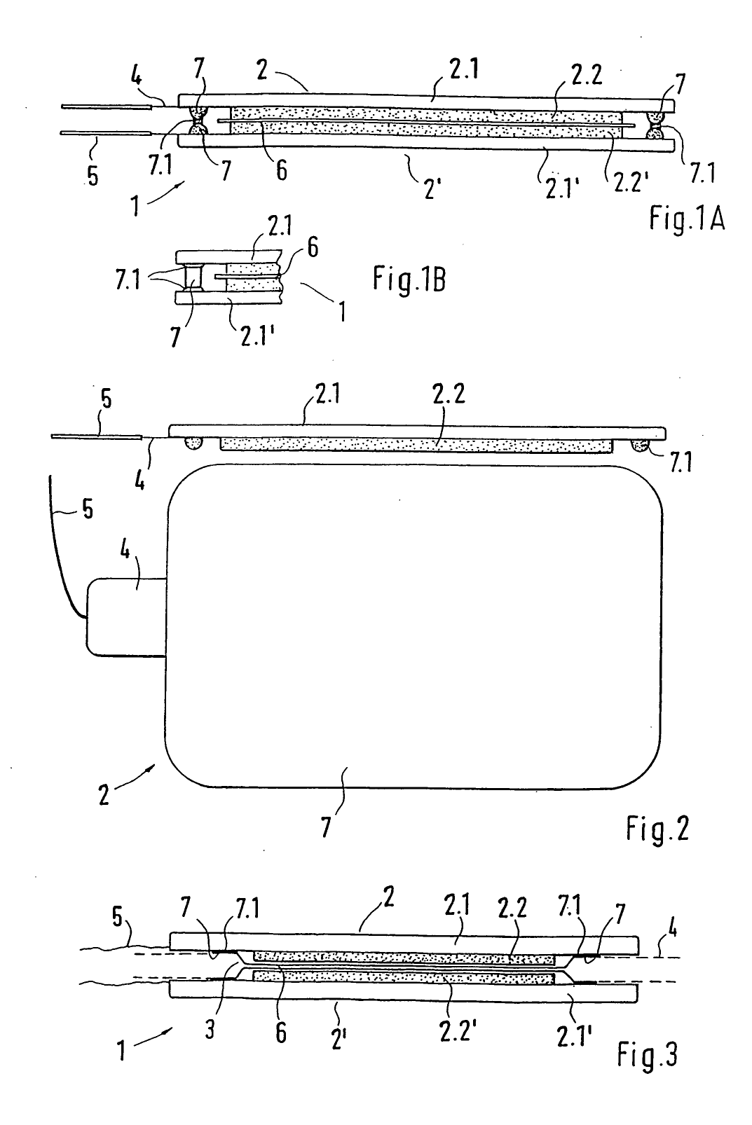

FIGS. 1A, 1B, 2 and 3 show different representations of an electrode pack 1, having a first and second electrode 2, 2′, each of which has an electrode body 2.1, 2.1′ with a contact area 2.2, 2.2′ with a contact layer to be placed against a patient. The contact areas of the two electrodes 2, 2′ face each other and are preferably separated by an intermediate layer 6. Connecting cables 5 for a connection with a control device, not shown, of a defibrilator are connected to each of the two electrode bodies 2.1, 2.1′ for charging the patient with a stimulating electrical voltage and, if desired, also to perform a functional test for determining the functional capability of the electrodes 2,2′ even in the packaged state. The contact areas 2.2, 2.2′ are closed in an airtight manner toward the exterior by a sealing arrangement with sealing means 7 and connecting means 7.1, so that the drying out of the gel layer, which is customarily provided in the contact area 2.2, 2.2′, is prevented, and the capability of the contact area to function is assured over a long period of time.

The sealing means 7 comprise a seal ring, which encircles the respective contact area 2.2, 2.2′ in an airtight manner, as shown in FIG. 2, for example. The connecting cables 5 are conducted out of the respective electrode bodies 2.1, 2.1′ outside of the seal ring. Thus the sealing means 7 can be embodied in different ways, as shown in FIGS. 1A to 3.

In accordance with FIG. 1A, a bead-like or lip-like seal ring is formed on, glued to or welded to each of the facing sides of the electrodes 2, 2′ of the electrode pack 1, on which contact areas 2.2, 2.2′ are also located. In the packaged state, the two seal rings of the respective electrodes 2,2′ are congruently connected with each other in their areas adjoining each other. Various connecting means 7.1 are conceivable for the connection, which make possible the simple pulling of the electrodes 2, 2′ apart from each other for their use, for example an adhesive, or their being welded together, or also a connection with a groove/protrusion arrangement, wherein the seal rings are made of a suitable elastic sealing material, for example silicon. With gripping tongues 4 attached to the electrode bodies 2.1, 2.1′ or to the sealing arrangement 7, which protrude laterally over the edges of the electrodes 2, 2′, the two electrodes can be easily grasped and pulled apart from each other. The connecting means 2.1 are matched so that they make possible the simple pulling apart and also assure an airtight closure. It is also possible to arrange several encircling seal rings next to each other.

FIG. 1B shows a sealing device which is modified from the exemplary embodiment of FIG. 1A, wherein the encircling sealing means 7 are embodied as a sealing element arranged between the facing sides of the two electrodes 2, 2′ and are glued together or welded together with the adjoining sides of the electrode bodies 2.1, 2.1′. Here a type of groove/protrusion connection as described in one embodiment above is possible. The connecting cables 5 are also conducted out of the respective electrode bodies 2.1, 2.1 outside of the sealing means 7. Also, gripping tongues 4 are advantageous.

With the embodiment represented in FIG. 3, the sealing means 7 are applied to a cover foil of the two contact areas 2.2, 2.2′ and form, for example, a part which is formed thereon in one piece, or is welded or is glued. In this case the cover foil, which forms the intermediate layer 6, can be embodied as a single layer with two edge areas separated from each other, or with two layers, each with an edge area, wherein the two layers are advantageously connected with each other for maintaining their positions. The sections projecting laterally beyond the respective contact areas 2.2, 2.2′ are connected with the respective electrode bodies 2.1, 2.1′ by connecting means 7.1 and form the sealing means 7. The connecting means 7.1 can be, for example, a suitable adhesive, or a welded connection for an airtight closure. For attachment of the gripping tongues 4 and the connection with the connecting cables 5, the electrode pack 1 is preferably embodied in accordance with the previously mentioned embodiments. If a dual-layer structure of the intermediate layer 6 is made of a foil-like packaging material 3, the connection between the two layers is stronger than the connection of the sealing means 7 with the electrode bodies 2.1, 2.1′, and the packaging material of the two electrodes 2, 2′ is separated from at least one electrode body 2.1, 2.1′ and can be easily removed from the electrodes.

With all mentioned exemplary embodiments, the intermediate layer 6 can be used as a dielectric device in order to perform an automatic electrode test from time to time and to register and assure the functional dependability of the electrodes 2, 2′.

1. An electrode pack having at least two flat electrodes (2, 2′), positionable against a patient, which have flat contact areas (2.2, 2.2′) with a gel on an electrode body (2.1, 2.1′), connecting cables (5), and an airtight connection (3, 6, 7), the electrode pack comprising:
a closure (3, 6, 7) having a seal (7, 7.1; 6.1) surrounding the contact areas (2.2, 2.2′) and contacting in an airtight manner electrode bodies (2.1, 2.1′), and the connecting cables (5) conducted out of the electrode bodies (2.1, 2.1′) outside of the seal (7, 7.1).

2. The electrode pack in accordance with claim 1, wherein the seal (7. 7.1) has an encircling seal ring arrangement (7) which is connected in an air-tight manner with both electrode bodies (2.1, 2.1′) by a connection (7.1), and can be pulled off.

3. The electrode pack in accordance with claim 2, wherein at least one of: the seal ring arrangement (7) has at least one sealing bead formed on each of facing sides of the electrode bodies (2.1, 2.1′) which contain the contact areas (2.2, 2.2′), and are congruent with respect to the two electrode bodies (2.1, 2.1 ′) and are connected with each other by the connection (7.1), and the at least one seal ring which encircles the contact areas (2.2, 2.2′) is arranged between the facing sides of the two electrode bodies (2.1, 2.1′) and is connected with the electrode bodies (2, 2′) on each of two sides of the at least one seal ring facing the electrode bodies (2, 2′) by the connection (7.1).

4. The electrode pack in accordance with claim 3, wherein at least one intermediate layer (6) is arranged between the two contact areas (2.2, 2.2′) facing each other.

5. The electrode pack in accordance with claim 2, wherein the seal ring arrangement (7) is a part of a foil covering the contact area (2.2, 2.2′) which forms at least one insulating intermediate layer (6) between the contact areas (2.2, 2.2′) facing each other, and the part is connected with an associated one of the electrode bodies (2.1, 2.1′) by the respective connection (7.1).

6. The electrode pack in accordance with claim 5, wherein at least one of the two electrodes (2, 2′) has at least one gripping tongue (4) for pulling the two electrodes (2, 2′) apart.

7. The electrode pack in accordance with claim 6, wherein the at least one gripping tongue (4) is connected to one of the seal ring arrangement (7), and the at least one intermediate layer (6).

8. The electrode pack in accordance with claim 7, wherein the at least one intermediate layer (6) is integrated for an electrical electrode test.

9. The electrode pack in accordance with claim 2, wherein at least one intermediate layer (6) is arranged between the two contact areas (2.2, 2.2′) facing each other.

10. The electrode pack in accordance with claim 1, wherein the seal ring arrangement (7) is a part of a foil covering the contact area (2.2, 2.2′) which forms at least one insulating intermediate layer (6) between the contact areas (2.2, 2.2′) facing each other, and the part is connected with an associated one of the electrode bodies (2.1, 2.1′) by the respective connection (7.1).

11. The electrode pack in accordance with claim 1, wherein at least one of the two electrodes (2, 2′) has at least one gripping tongue (4) for pulling the two electrodes (2, 2′) apart.

12. The electrode pack in accordance with claim 11, wherein the at least one gripping tongue (4) is connected to one of the seal ring arrangement (7) and the at least one intermediate layer (6).

13. The electrode pack in accordance with claim 4, wherein the at least one intermediate layer (6) is integrated for an electrical electrode test.
